(19) United States
(12) Patent Application Publication
(10) Pub. No.: US 2026/0044845 A1
(43) Pub. Date: Feb. 12, 2026

(54) Smart Cart Object Identification

(71) Applicant: Toshiba Global Commerce Solutions, Inc., Durham, NC (US)

(72) Inventors: James Frank, Montreal (CA); Yevgeni Tsirulnik, Frisco, TX (US); Yeshai Bouskila, Plano, TX (US)

(73) Assignee: Toshiba Global Commerce Solutions, Inc., Durham, NC (US)

(21) Appl. No.: 19/069,614

(22) Filed: Mar. 4, 2025

Related U.S. Application Data
(60) Provisional application No. 63/680,374, filed on Aug. 7, 2024.

(51) Int. Cl. G06Q 20/20; B62B 5/00; G06V 20/52; H04N 7/18

(52) U.S. Cl. CPC G06Q 20/208; B62B 5/0096; G06Q 20/201; G06V 20/52; H04N 7/18

(57) ABSTRACT

Methods and systems of an intelligent shopping cart apparatus are provided. In one exemplary embodiment, a method is performed by an apparatus configured to be mechanically coupled to a cart. Further, the apparatus includes a coupling mechanism configured to suspend a container from the apparatus and a processing circuitry operationally coupled to a weight sensor operable to measure the weight of an object disposed in the container while suspended from the apparatus by the coupling mechanism. The method includes sending, by the processing circuitry, an indication associated with a weight-related price of an object based on the weight measurement of the object disposed in the container while suspended from the apparatus by the coupling mechanism and a price per unit of weight of a selected retail item corresponding to the object.

### CROSS REFERENCE TO RELATED APPLICATIONS

The present application is a nonprovisional of and claims the benefit of U.S. Provisional App. No. 63/680,374, filed Aug. 7, 2024, which is hereby incorporated by reference in its entirety as if fully set forth herein.

### BACKGROUND

Shopping carts are wheeled baskets used by customers in retail stores to collect and transport items while shopping. They are typically made of metal or plastic and designed for ease of use within store aisles, featuring a handle for pushing, a basket for storing goods, and wheels for mobility. Smart shopping carts are an advanced version equipped with technology such as sensors, cameras, and touchscreens to enhance the shopping experience. These carts can track items placed in the cart, provide product recommendations, facilitate self-checkout, and integrate with mobile apps for personalized services, improving convenience and efficiency for both customers and retailers. The Background section of this document is provided to place embodiments of the present disclosure in technological and operational context, to assist those of skill in the art in understanding their scope and utility. Unless explicitly identified as such, no statement herein is admitted to be prior art merely by its inclusion in the Background section.

### BRIEF DESCRIPTION OF THE DRAWINGS

The present disclosure will now be described more fully hereinafter with reference to the accompanying drawings, in which embodiments of the disclosure are shown. However, this disclosure should not be construed as limited to the embodiments set forth herein. Rather, these embodiments are provided so that this disclosure will be thorough and complete, and will fully convey the scope of the disclosure to those skilled in the art. Like numbers refer to like elements throughout.

FIG. 1A illustrates one embodiment of a system having an apparatus coupled to a shopping cart in accordance with various aspects as described herein. FIG. 1B illustrates another embodiment of a system having an apparatus coupled to a shopping cart in accordance with various aspects as described herein. FIG. 1C illustrates another embodiment of a system having an apparatus coupled to a shopping cart in accordance with various aspects as described herein.

FIG. 2 illustrates one embodiment of an apparatus in accordance with various aspects as described herein.

FIG. 3 illustrates another embodiment of an apparatus in accordance with various aspects as described herein.

FIG. 4A illustrates one embodiment of a method performed by an apparatus in accordance with various aspects as described herein. FIG. 4B-C illustrate other embodiments of a method performed by an apparatus in accordance with various aspects as described herein.

FIG. 5 illustrates another embodiment of an apparatus in accordance with various aspects as described herein.

### DETAILED DESCRIPTION

For simplicity and illustrative purposes, the present disclosure is described by referring mainly to an exemplary embodiment thereof. In the following description, numerous specific details are set forth in order to provide a thorough understanding of the present disclosure. However, it will be readily apparent to one of ordinary skill in the art that the present disclosure may be practiced without limitation to these specific details.

For smart carts to sell unpacked bulk produce items, the items must be accurately weighed to determine the final sale price so that they can be added to the order basket. This weight measurement electronic device can be configured to be weights and measures (W&M)-certified so that the device can be legally used to provide a retail sale price. A W&M-certified scale electronic device adds complexity and cost to smart carts. Several solutions currently exist in the marketplace. For instance, some smart cart solutions include a platter scale apparatus coupled to the handlebar-mounted control device. This solution can add significant weight and size to the overall smart cart and is also expensive and prone to damage. Other smart cart solutions can integrate weight sensors with the smart cart such as coupled to the wheels of the smart cart or at the point of contact of the main cart basket. These weight sensors can be operable to detect a change in the total weight of the entire cart. These solutions can also be expensive and difficult to repair if damaged. In addition, the W&M-certified scale electronic device can be permanently affixed to the smart cart, limiting the smart cart to indoor use only, which may require a customer to transfer items from the smart cart to a non-smart cart such as to reach a parked car in the rain. Further, any repairs to these smart cart solutions can not only be costly and likely require a visit by an expert technician but also removes the cart from use by customers. The technological complexities and cost of these smart cart solutions have hindered the operational and financial viability of smart carts in the market, substantially reducing the adoption of smart carts by retail stores. Other use cases of smart cart solutions can include implementations that use computer vision systems or low-cost weight measurement solutions that do not require W&M certification. However, it is expected that the market will require a smart cart solution that is low cost, easy to maintain, removable, and W&M certified.

In this disclosure, exemplary embodiments include an electronic W&M-certified scale device operable to weigh and identify produce on shopping carts such as integrated with a smart cart solution. For example, this electronic scale device can include a mechanical hook structure coupled to an electronic scale device. The hook structure can be configured to couple and suspend a container (e.g., bag) holding produce so that the scale is enabled to measure the weight of that produce while suspended by the hook structure. In addition, this electronic scale device can include a downward facing camera operable to capture an image of at least a portion of the produce while disposed in the container so that the produce can be identified based on the captured image. A processing circuitry coupled to the electronic scale device and the camera can be operable to receive the weight measurement of the produce and the image that includes the display of at least a portion of the produce disposed in the container. The processing circuitry can be operable to classify or identify the produce item and obtain the price of that classified or identified produce item based on the weight measurement and the image. The device can be configured to be mechanically coupled to the handlebars of a smart cart or mechanically integrated to the controller of the smart cart.

In one exemplary embodiment, a method is performed by an apparatus having a sensor device with a downward facing camera and an electronic W&M-certified scale device operationally coupled to a mechanical hook structure. The apparatus can also include a controller device having a presence sensitive display (e.g., touchscreen). The method can include placing produce in a container (e.g., produce bag, disposable bag, reusable bag). Further, the method can include suspending that container having the produce from the mechanical hook structure of the electronic scale device. The method can include obtaining, by the electronic scale, a weight measurement of the produce disposed in the container while suspended from the mechanical hook structure. The method can also include sending, by the electronic scale device, to the controller device, an indication that includes the weight measurement of the produce disposed in the container. In addition, the method can include capturing, by the downward facing camera, an image that includes at least a portion of the produce disposed in the container while suspended from the mechanical hook structure. The method can also include sending, by the electronic scale device, to the controller device, an indication that includes data that represents the image. The method can include classifying or identifying the produce based on the weight measurement and the image data. In one example, the method can send, by the processing circuitry of the controller device, to artificial intelligence circuitry, an indication that includes the weight measurement and the image data. The artificial intelligence circuit can be operable to classify or identify one of a set of produce items based on the weight measurement and/or the image data, with the artificial intelligence circuit being trained on weight measurements and/or image data that represents images of the set of produce items. The method can include receiving, by the processing circuitry of the controller device, from the artificial intelligence circuitry, an indication that includes at least one predicted produce item and corresponding confidence levels. The method can then include selecting the produce item based on the at least one predicted produce items and the corresponding confidence levels. For example, the method can include selecting the at least one predicted produce time that has the highest confidence level. Further, the method can include outputting, for display on the presence-sensitive display of the apparatus, an indication that includes a visual representation of the selected produce item for verification. In response, the method can include receiving, by the controller device, from the presence sensitive display, an indication that the selected produce item is verified. The method can then include determining, by the controller device, a price of the selected produce item based on the weight measurement of the produce item and a price per unit of weight of that produce item.

The benefits of this apparatus include a low cost, low maintenance weight and measure-certified electronic scale device that can be retrofitted onto current shopping carts and/or integrated with the controller devices of current smart shopping carts. Further, this apparatus can be easily removed from a shopping cart for repair, upgrade, battery charging, or replacement. In addition, this apparatus can include a camera to identify the produce disposed in the suspended container.

In another exemplary embodiment, the apparatus can include only the electronic scale device operable to indicate a weight measurement of the suspended produce. This measured weight can then be manually entered into a POS system enabled to determine a product price based on the weight measurement of that produce and a price per unit of weight of that produce.

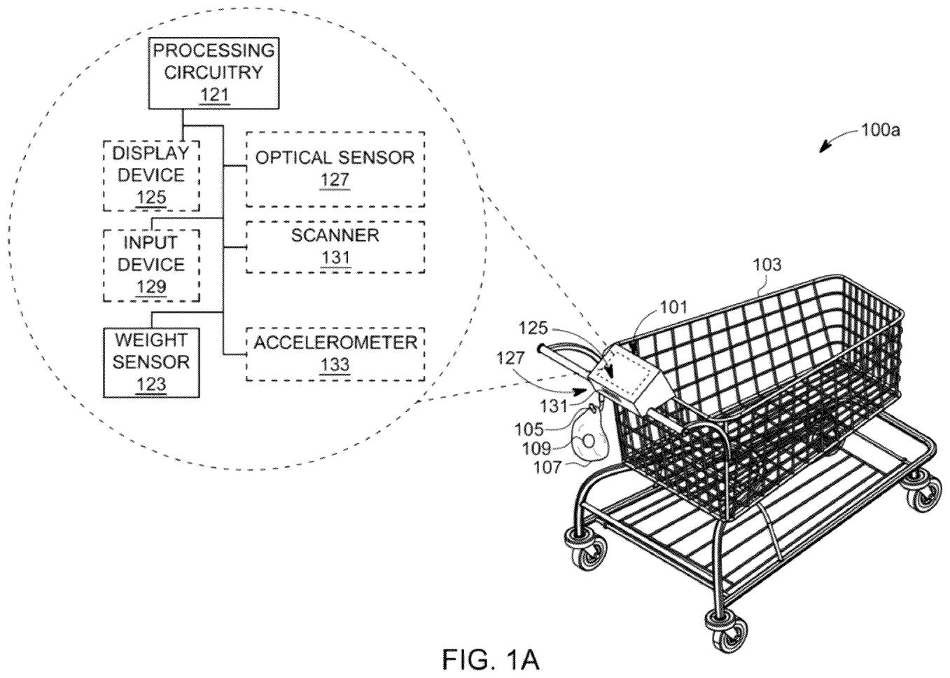

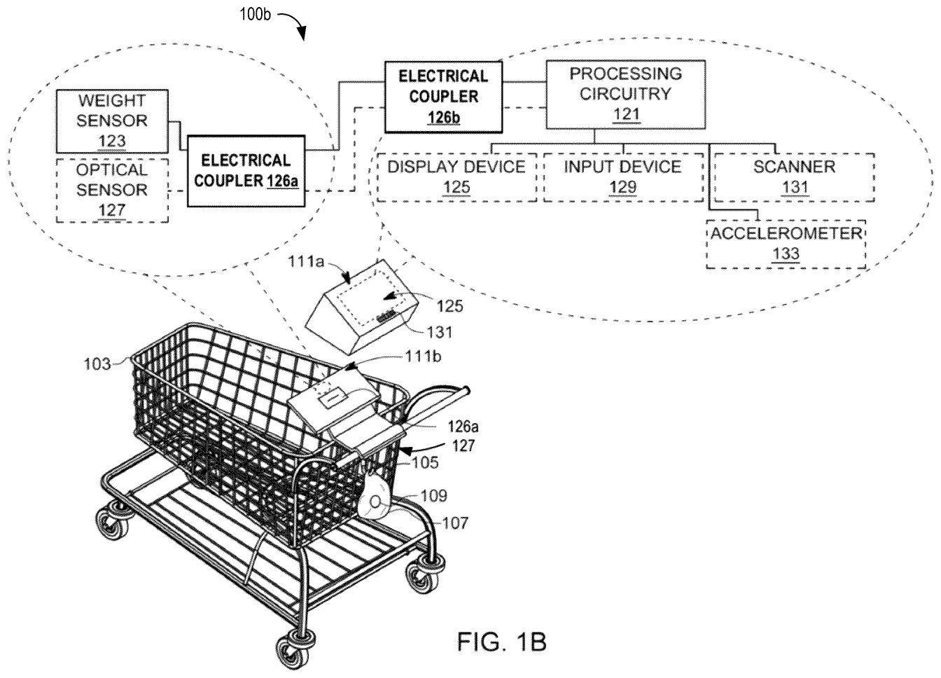

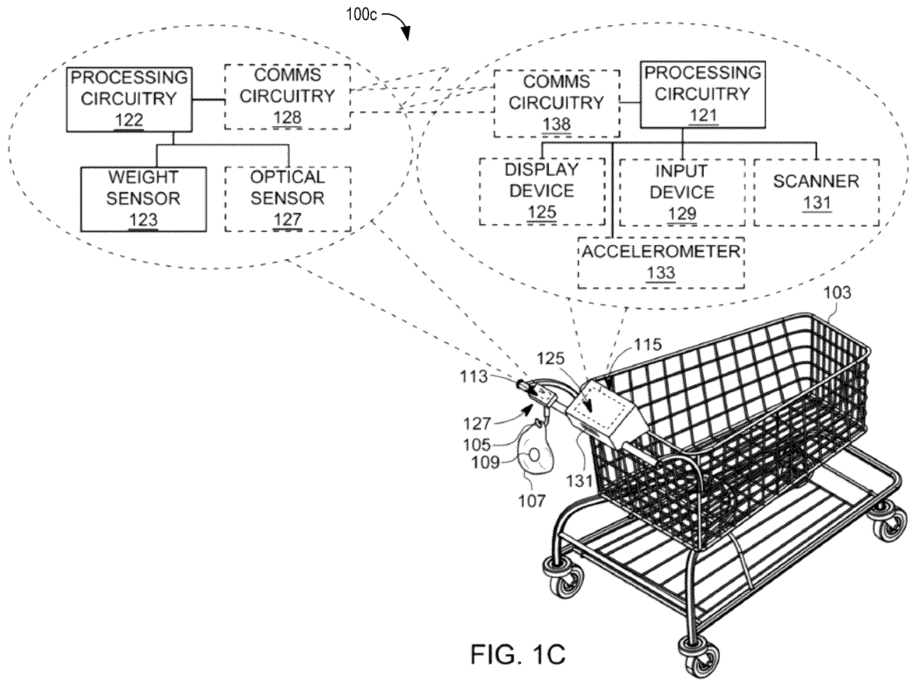

FIG. 1A illustrates one embodiment of a system 100a having an apparatus 101 coupled to a shopping cart 103 in accordance with various aspects as described herein. The system 100a can include the apparatus 101 having a coupling mechanism 105 (e.g., mechanical hook) configured to suspend a container 107 (e.g., shopping bag, basket, plastic bag) from the apparatus 101 and a processing circuitry 121 operationally coupled to an electronic weight sensor 123 (e.g., electronic scale) operable to measure a weight of the object 109 (e.g., retail item, produce, any item that requires a weight measurement) disposed in the container 107 while suspended from the apparatus 101 by the coupling mechanism 105. The apparatus 101 can further include processing circuitry 121 operationally coupled to a display device 125 (e.g., touchscreen) an optical sensor 127 (e.g., camera), an input device (e.g., touchscreen), a scanner 131 (e.g., barcode scanner), an accelerometer 133, or the like. The optical sensor device 127 can be configured with a downward field of view and can be operable to capture an image of at least a portion of the object 109 disposed in the container 107 while suspended from the apparatus 101 by the coupling mechanism 105. The apparatus 101 can further include a memory operationally coupled to the processing circuitry 121, the memory containing instructions executable by the processing circuitry 121. The processing circuitry 121 can be operable to receive, from the weight sensor 123, an indication that includes a weight measurement of the object 109 of a set of objects (e.g., retail items, produce) that is disposed in the container 107 while the container 107 is suspended from the apparatus 101 by the coupling mechanism 105 so that the processing circuitry 121 is enabled to determine a price of the object 109 based on the weight measurement of that object 109 and a price per unit of weight of that object 109. Further, the processing circuitry 121 can be operable to receive, from the optical sensor 127, an indication that includes data that represents an image that displays at least a portion of the object 109 disposed in the container 107 while the container 107 is suspended from the apparatus 101 by the coupling mechanism 105 so that the processing circuitry 121 is enabled to classify or identify the object 109 as being one of the set of objects.

FIG. 1B illustrates another embodiment of a system 100b having an apparatus 111a, b coupled to a shopping cart 103 in accordance with various aspects as described herein. The system 100b can include the apparatus 101 having a controller device 111a, a mounting mechanism 111b, or the like. The mounting mechanism 111b can be configured to be mechanically and electrically coupled to the controller device 111a and can be mechanically coupled to the cart 103. The mounting mechanism 111b can include the coupling mechanism 105, the weight sensor 123, the optical sensor 127, or the like. The coupling mechanism 105 can be configured to suspend the container 107 from the mounting mechanism 111b. Further, the weight sensor 123 can be operable to measure the weight of the container 107 while suspended from the mounting mechanism 111b by the coupling mechanism 105. The optical sensor 127 (e.g., camera) can be configured with a downward field of view and can be operable to capture an image of at least a portion of the object 109 disposed in the container 107 while suspended from the mounting mechanism 111b by the coupling mechanism 105. The controller device 111a can include a processing circuitry 121 electrically coupled to a display device 125, an electrical coupler 126b, an input device 129, a scanner 131, an accelerometer 133, or the like. Further, the processing circuitry 121 can be electrically coupled to the weight sensor 123 and the optical sensor 127 of the mounting mechanism 111b through the electrical couplers 126a, b (e.g., electrical connectors, electrical contacts) while the controller device 111a is mechanically coupled to the mounting mechanism 111b to enable the electrical couplers 126a, b to be electrically coupled. The weight sensor 123 of the mounting mechanism 111b can be operable to send, to the processing circuitry 121 of the controller device 111a, an indication that includes a weight measurement of a certain object 109 of a set of objects that is disposed in the container 107 while the container 107 is suspended from the mounting mechanism 111b by the coupling mechanism 105 so that the processing circuitry 121 is enabled to determine a price of the certain object 109 based on the weight measurement of that object 109 and a price per unit of weight of that object 109. Further, the processing circuitry 121 can be configured to receive, from the optical sensor 127, an indication that includes data that represents an image that displays at least a portion of the object 109 disposed in the container 107 while the container 107 is suspended from the mounting mechanism 111b by the coupling mechanism 105 so that the processing circuitry 121 is enabled to classify or identify the object 109 as being one of the set of objects.

FIG. 1C illustrates another embodiment of a system 100c having an apparatus 115 mechanically coupled to a shopping cart 103 in accordance with various aspects as described herein. In FIG. 1C, the apparatus 101 can include a sensor device 113 and a controller device 115. The sensor device 113 can be configured to be mechanically coupled to the cart 103 and operationally coupled to the controller device 115. Further, the controller device 115 can be mechanically coupled to the shopping cart 103. The sensor device 113 can include the coupling mechanism 105 configured to suspend the container 107 from the sensor device 113. In addition, the sensor device 113 can include a processing circuitry 122 electrically coupled to the weight sensor 123, the optical sensor 127, communications circuitry 128, or the like. The weight sensor 123 can be operable to measure a weight of the container 107 while suspended from the sensor device 113 by the coupling mechanism 105. The optical sensor 127 (e.g., camera) can be configured with a downward field of view and can be operable to capture an image of at least a portion of the object 109 disposed in the container 107 while suspended from the sensor device 113 by the coupling mechanism 105. The communications circuitry 128 can be operable to send or receive information over a wired or wireless connection. The sensor device 113 can be operable to send, by the processing circuitry 122 over the communications circuitry 128, to the controller device 115, an indication that includes a weight measurement of the certain object 109 of the set of objects that is disposed in the container 107 while the container 107 is suspended from the sensor device 113 by the coupling mechanism 105 so that the controller device 115 is enabled to determine a price of the certain object 109 based on the weight measurement of that object 109 and a price per unit of weight of that object 109. Further, the processing circuitry 122 can be operable to receive, from the optical sensor 127, an indication that includes data that represents an image that displays at least a portion of the object 109 disposed in the container 107 while the container 107 is suspended from the sensor device 113 by the coupling mechanism 105. The processing circuitry 122 can then send, over the communications circuitry 128, to the controller device 115, an indication that includes the image data so that the controller device 115 is enabled to classify or identify the object 109 as being one of the set of objects.

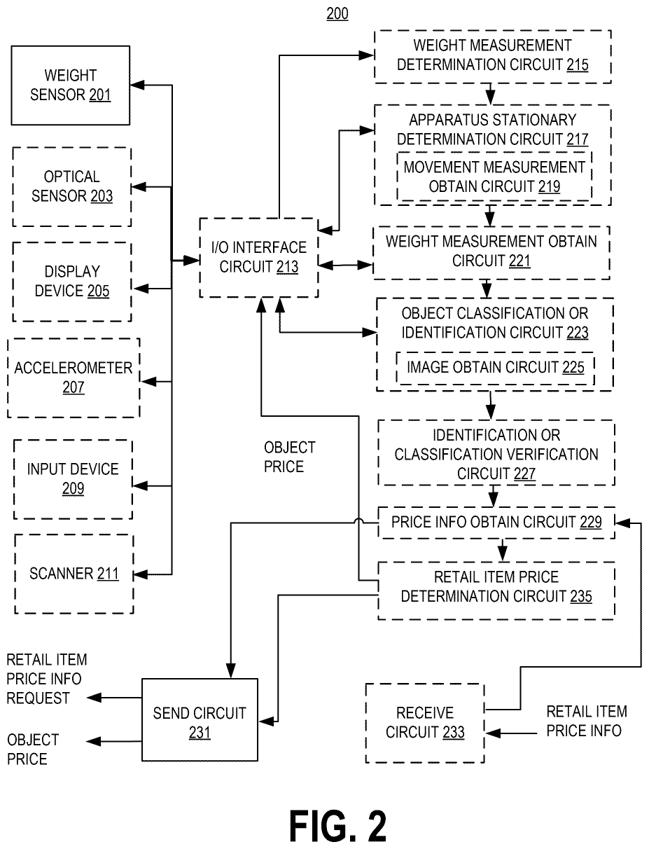

FIG. 2 illustrates one embodiment of an apparatus 200 in accordance with various aspect as described herein. In FIG. 2, the apparatus 200 implements various functional means, units, modules (e.g. via a processing circuitry, software code, or the like), or circuits. In one embodiment, these functional means, units, modules, or circuits (e.g., for implementing the method(s) described herein) may include for instance an input or output interface circuit 213 operable to transfer information to or from the functional means, units, modules, or circuits of the apparatus 200. The input/output interface circuit 213 can be further operable to transfer information to or from the functional means, units, modules, or circuits and any of the following devices: a weight sensor 201 (e.g., scale), an optical sensor 203 (e.g., camera), a display device 205 (e.g., touchscreen), a motion sensor 207 (e.g., an accelerometer), an input device 209 (e.g., touchscreen, keyboard, microphone), a scanner 211 (e.g., barcode scanner), or the like.

These functional means, units, modules or circuits can include a weight measurement determination circuit 215 operable to determine a weight measurement of an object (e.g., retail item); an apparatus stationary determination circuit 217 operable to determine that the apparatus 200 is stationary based on a motion measurement obtained from the accelerometer 207; a movement measurement obtain circuit 219 operable to obtain a motion measurement of the apparatus 200; a weight measurement obtain circuit 221 operable to obtain a weight measurement of a container suspended by a coupling mechanism; an object classification or identification circuit 223 operable to classify or identify the object based on the weight measurement of the object or the data representing the image of the object; an image obtain circuit 225 operable to obtain data that represents an image; an identification or classification verification circuit 227 operable to determine that an object corresponds to a predicted object; a price information obtain circuit 229 operable to obtain a price per unit of weight of the selected object; a send circuit 231 operable to send information; a receive circuit 233 operable to receive information; and a retail price item determination circuit 235 operable to determine the price of the object based on the weight measurement of that object and the price per unit of weight of that object.

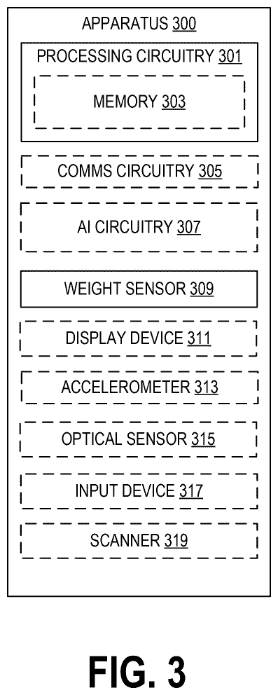

FIG. 3 illustrates another embodiment of an apparatus 300 in accordance with various aspect as described herein. In FIG. 3, the apparatus 300 can include processing circuitry 301 operably coupled to one or more of the following: a memory 303, a network communications circuitry 305, an artificial intelligence (AI) circuitry 307, a weight sensor 309, a display device 311, a motion sensor 313, an optical sensor 315, an input device 317, a scanner 319, the like, or any combination thereof. The network communications circuitry 305 can be configured to transmit and/or receive information to and/or from one or more network node devices via any communication technology. The processing circuitry 301 can be configured to perform processing described herein, such as by executing instructions stored in the memory 303. The processing circuitry 301 in this regard may implement certain functional means, units or modules. The artificial intelligence circuitry 307 can be associated with identifying or classifying an object, can be operable to predict an object, can be trained on information associated with a set of objects, or the like. The weight sensor 309 can be operable to perform a weight measurement, the display device 311 can be operable to display information, the motion sensor 313 can be operable to measure motion, the optical sensor 315 can be operable to capture an image, the input device 317 can be operable to receive an input such as from a user, and the scanner 319 can be operable to scan a visual code (e.g., barcode).

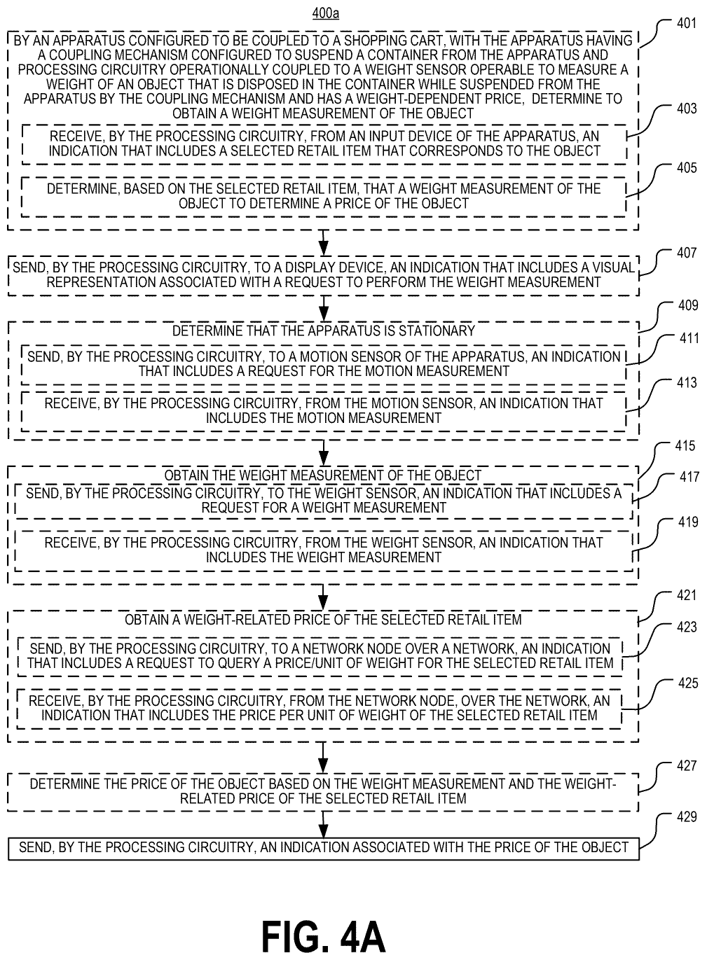

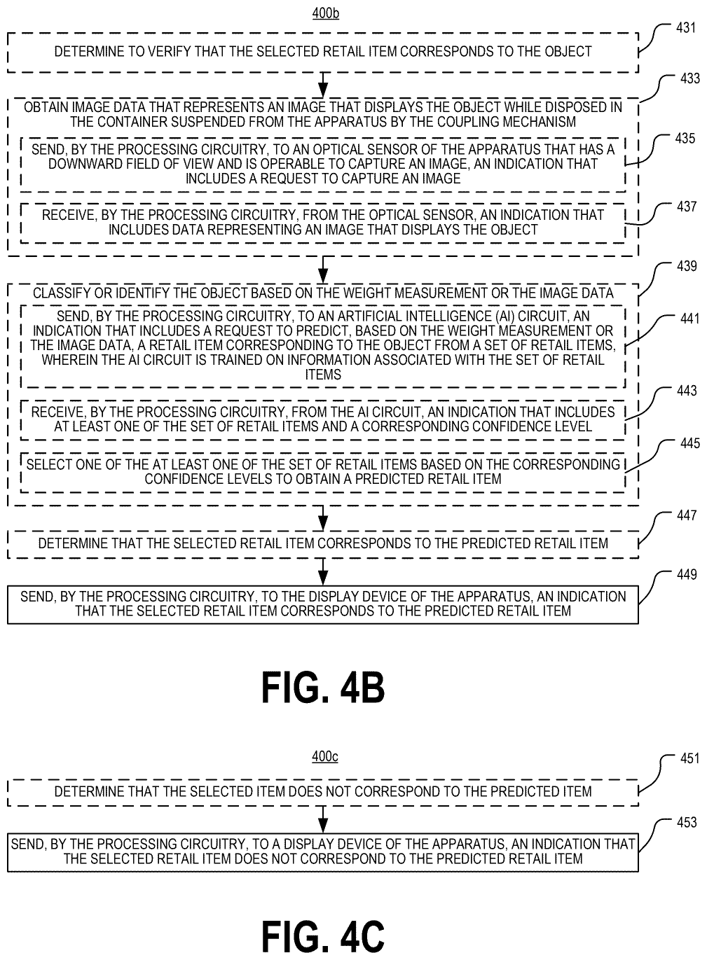

FIG. 4A illustrates one embodiment of a method 400a performed by an apparatus in accordance with various aspects as described herein. In FIG. 4A, the method 400a may start, for instance, at block 401, where the method 400a can include determining to obtain a weight measurement of an object (e.g., produce). At block 403, the method 400a may include receiving, by the processing circuitry, from an input device (e.g., touchscreen, input key) of the apparatus, an indication that includes a selected retail item that corresponds to the object. At block 405, the method 400a may further include determining, based on the selected retail item, that a weight measurement of the object is requested. At block 407, the method 400a can include sending, by the processing circuitry, to the display device, an indication that includes a visual representation associated with a request to perform the weight measurement of the object. At block 409, the method 400a can include determining that the apparatus is stationary based on a motion measurement of the apparatus. At block 411, the method 400a may include sending, by the processing circuitry, to a motion sensor (e.g., accelerometer, gyroscope) of the apparatus, an indication that includes a request for the motion measurement of the apparatus. At block 413, the method 400a may further include receiving, by the processing circuitry, from the motion sensor, an indication that includes the motion measurement of the apparatus. At block 415, the method 400a can include obtaining the weight measurement of the object. At block 417, the method 400a may include sending, by the processing circuitry, to the weight sensor, an indication that includes a request for the weight measurement of the object disposed in a container (e.g., bag) while suspended from the apparatus via a coupling mechanism (e.g., hook). At block 419, the method 400a may further include receiving, by the processing circuitry, from the weight sensor, an indication that includes the weight measurement of the container having the object. The method 400a can further include determining the weight measurement of the object based on the weight measurement of the container having the object. At block 421, the method 400a can include obtaining a price per unit of weight of the selected retail item. At block 423, the method 400a may include sending, by the processing circuitry, to a network node, over a network, an indication that includes a request to query a price per unit of weight for the selected retail item. At block 425, the method 400a may further include receiving, by the processing circuitry, from the network node, over the network, an indication that includes the price per unit of weight of the selected retail item. At block 427, the method 400a can include determining the price of the object based on the weight measurement and the price per unit of weight of the selected retail item. At block 429, the method 400a includes sending, by the processing circuitry, an indication associated with the price of the object.

FIG. 4B illustrates another embodiment of a method 400b performed by an apparatus in accordance with various aspect as described herein. The method 400b can include any of the steps of method 400a and may start at block 431, where the method 400b can include determining to verify that the selected retail item corresponds to the object. At block 433, the method 400b can include obtaining image data that represents an image that displays the object disposed in the container while suspended from the apparatus by the coupling mechanism. At block 435, the method 400b may include sending, by the processing circuitry, to an optical sensor (e.g., camera) of the apparatus that has a downward field of view towards the contents of the container and operable to capture an image, an indication that includes a request to capture an image. At block 437, the method 400b may further include receiving, by the processing circuitry from the optical sensor, an indication that includes data representing an image that displays the object disposed in the container. At block 439, the method 400b can include classifying or identifying the object based on the weight measurement or the image data. At block 441, the step of block 439 may include sending, by the processing circuitry, to an artificial intelligence (AI) circuit, an indication that includes a request to predict, based on the weight measurement or the image data, a retail item that corresponds to the object from a set of retail items, wherein the AI circuit is trained on information (e.g., weight, image data) associated with the set of retail items. At block 443, the method 400b may further include receiving, by the processing circuitry, from the AI circuit, an indication that includes at least one of the set of retail items and a corresponding confidence level. At block 445, the method 400b may further include selecting one of the at least one of the set of retail items based on the corresponding confidence levels to obtain a predicted retail item. At block 447, the method 400b can include determining that the selected retail item corresponds to the predicted retail item. At block 449, the method 400b includes sending, by the processing circuity, to the display device of the apparatus, an indication that the selected retail item corresponds to the predicted retail item.

FIG. 4C illustrates another embodiment of a method 400c performed by an apparatus in accordance with various aspect as described further herein. The method 400c can include any of the steps of method 400a or method 400b and may start at, for instance, block 451 where it can include determining that the selected retail item does not correspond to the predicted retail item. At block 453, the method 400c includes sending, by the processing circuitry, to the display device of the apparatus, an indication that the selected retail item does not correspond to the predicted retail item.

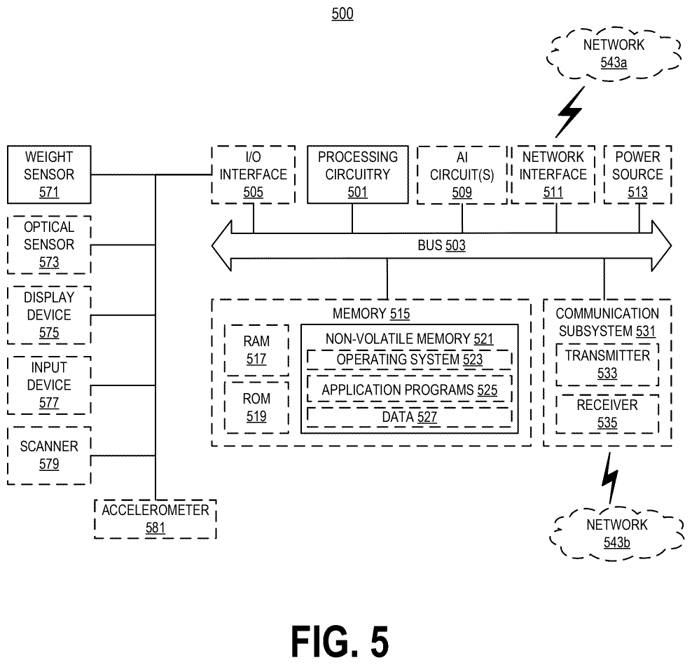

FIG. 5 illustrates another embodiment of an apparatus 500 in accordance with various aspects as described herein. In FIG. 5, apparatus 500 includes processing circuitry 501 that is operatively coupled to input/output interface 505, artificial intelligence (AI) circuit 509, network connection interface 511, memory 515 including random access memory (RAM) 517, read-only memory (ROM) 519, and non-volatile memory 521 or the like, communication subsystem 531, power source 513, and/or any other component, or any combination thereof.

The input/output interface 505 may be configured to provide a communication interface to an input device, output device, or input and output device. The apparatus 500 may be configured to use an output device 561 via input/output interface 505. An output device 561 may use the same type of interface port as an input device. For example, a USB port may be used to provide input to and output from the apparatus 500. The output device 561 may be a speaker, a sound card, a video card, a display device 575 (e.g., presence-sensitive display), a monitor, a printer, an actuator, an emitter, a smartcard, another output device, or any combination thereof. The apparatus 500 may be configured to use an input device via input/output interface 505 to allow a user to capture information into the apparatus 500. The input device may include a weight sensor 571 (e.g., electronic weight scale), an optical sensor 573 (e.g., camera), a display device 575 (e.g., a touch-sensitive or presence-sensitive display), another input device 577, a scanner 579 (e.g., barcode scanner) an accelerometer 581, a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical or image sensor, an infrared sensor, a proximity sensor, another like sensor, or any combination thereof.

In FIG. 5, non-volatile memory 521 may include operating system 523, application program 525, data 527, the like, or any combination thereof. In other embodiments, non-volatile memory 521 may include other similar types of information. Certain devices may utilize all of the components shown in FIG. 5, or only a subset of the components. The level of integration between the components may vary from one device to another device. Further, certain devices may contain multiple instances of a component, such as multiple processors, memories, neural networks, network connection interfaces, transceivers, etc.

In FIG. 5, processing circuitry 501 may be configured to process computer instructions and data. Processing circuitry 501 may be configured to implement any sequential state machine operative to execute machine instructions stored as machine-readable computer programs in the memory, such as one or more hardware-implemented state machines (e.g., in discrete logic, FPGA, ASIC, etc.); programmable logic together with appropriate firmware; one or more stored program, general-purpose processors, such as a microprocessor or Digital Signal Processor (DSP), together with appropriate software; or any combination of the above. For example, the processing circuitry 501 may include two central processing units (CPUs). Data may be information in a form suitable for use by a computer.

In FIG. 5, the AI circuit 509 may be configured to learn to perform tasks by considering examples such as performing object detection of certain objects in an image. In one example, a first AI circuit is configured to perform object detection or identification, in an image, of subjects, faces of subjects, vehicles, license plates on vehicles, or the like. Further, a second AI circuit is configured to perform detection of an activity of a subject. In FIG. 5, the network connection interface 511 may be configured to provide a communication interface to network 543a. The network 543a may encompass wired and/or wireless networks such as a local-area network (LAN), a wide-area network (WAN), a computer network, a wireless network, a telecommunications network, another like network or any combination thereof. For example, network 543a may comprise a Wi-Fi network. The network connection interface 511 may be configured to include a receiver and a transmitter interface used to communicate with one or more other devices over a communication network according to one or more communication protocols, such as Ethernet, TCP/IP, SONET, ATM, or the like. The network connection interface 511 may implement receiver and transmitter functionality appropriate to the communication network links (e.g., optical, electrical, and the like). The transmitter and receiver functions may share circuit components, software or firmware, or alternatively may be implemented separately.

The RAM 517 may be configured to interface via a bus 503 to the processing circuitry 501 to provide storage or caching of data or computer instructions during the execution of software programs such as the operating system, application programs, and device drivers.

The ROM 519 may be configured to provide computer instructions or data to processing circuitry 501. For example, the ROM 519 may be configured to store invariant low-level system code or data for basic system functions such as basic input and output (I/O), startup, or reception of keystrokes from a keyboard that are stored in a non-volatile memory. The non-volatile memory 521 may be configured to include memory such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, or flash drives. In one example, the non-volatile memory 521 may be configured to include an operating system 523, an application program 525 such as web browser, web application, user interface, browser data manager as described herein, a widget or gadget engine, or another application, and a data file 527. The non-volatile memory 521 may store, for use by the apparatus 500, any of a variety of various operating systems or combinations of operating systems.

The non-volatile memory 521 may be configured to include a number of physical drive units, such as redundant array of independent disks (RAID), floppy disk drive, flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as a subscriber identity module or a removable user identity (SIM/RUIM) module, other memory, or any combination thereof. The non-volatile memory 521 may allow the apparatus 500 to access computer-executable instructions, application programs or the like, stored on transitory or non-transitory memory media, to off-load data, or to upload data. An article of manufacture, such as one utilizing a communication system may be tangibly embodied in the non-volatile memory 521, which may comprise a device readable medium.

The processing circuitry 501 may be configured to communicate with network 543b using the communication subsystem 531. The network 543a and the network 543b may be the same network or networks or different network or networks. The communication subsystem 531 may be configured to include one or more transceivers used to communicate with the network 543b. For example, the communication subsystem 531 may be configured to include one or more transceivers used to communicate with one or more remote transceivers of another device capable of wireless communication according to one or more communication protocols, such as IEEE 802.11, CDMA, WCDMA, GSM, LTE, UTRAN, WiMax, or the like. Each transceiver may include transmitter 533 and/or receiver 535 to implement transmitter or receiver functionality, respectively, appropriate to the RAN links (e.g., frequency allocations and the like). Further, transmitter 533 and receiver 535 of each transceiver may share circuit components, software, or firmware, or alternatively may be implemented separately.

In FIG. 5, the communication functions of the communication subsystem 531 may include data communication, voice communication, multimedia communication, short-range communications such as Bluetooth, near-field communication, location-based communication such as the use of the global positioning system (GPS) to determine a location, another like communication function, or any combination thereof. For example, the communication subsystem 531 may include cellular communication, Wi-Fi communication, Bluetooth communication, and GPS communication. The network 543b may encompass wired and/or wireless networks such as a local-area network (LAN), a wide-area network (WAN), a computer network, a wireless network, a telecommunications network, another like network or any combination thereof. For example, the network 543b may be a cellular network, a Wi-Fi network, and/or a near-field network. The power source 513 may be configured to provide alternating current (AC) or direct current (DC) power to components of the apparatus 500.

The features, benefits and/or functions described herein may be implemented in one of the components of the apparatus 500 or partitioned across multiple components of the apparatus 500. Further, the features, benefits, and/or functions described herein may be implemented in any combination of hardware, software, or firmware. In one example, communication subsystem 531 may be configured to include any of the components described herein. Further, the processing circuitry 501 may be configured to communicate with any of such components over the bus 503. In another example, any of such components may be represented by program instructions stored in memory that when executed by the processing circuitry 501 perform the corresponding functions described herein. In another example, the functionality of any of such components may be partitioned between the processing circuitry 501 and the communication subsystem 531. In another example, the non-computationally intensive functions of any of such components may be implemented in software or firmware and the computationally intensive functions may be implemented in hardware.

Those skilled in the art will also appreciate that embodiments herein further include corresponding computer programs.

A computer program comprises instructions which, when executed on at least one processor of an apparatus, cause the apparatus to carry out any of the respective processing described above. A computer program in this regard may comprise one or more code modules corresponding to the means or units described above.

Embodiments further include a carrier containing such a computer program. This carrier may comprise one of an electronic signal, optical signal, radio signal, or computer readable storage medium.

In this regard, embodiments herein also include a computer program product stored on a non-transitory computer readable (storage or recording) medium and comprising instructions that, when executed by a processor of an apparatus, cause the apparatus to perform as described above.

Embodiments further include a computer program product comprising program code portions for performing the steps of any of the embodiments herein when the computer program product is executed by a computing device. This computer program product may be stored on a computer readable recording medium.

Additional embodiments will now be described. At least some of these embodiments may be described as applicable in certain contexts for illustrative purposes, but the embodiments are similarly applicable in other contexts not explicitly described.

In one exemplary embodiment, a method is performed by a sensor device operationally coupled to a controller device. The sensor device is also configured to be mechanically coupled to the shopping cart, with the sensor device having a coupling mechanism configured to suspend a container from the sensor device and processing circuitry operationally coupled to a weight sensor operable to measure a weight of the container while suspended from the sensor device by the coupling mechanism. The method includes sending, by the sensor device, to the controller device, an indication that includes a weight measurement of a certain object of a set of objects that is disposed in the container while the container is suspended from the sensor device by the coupling mechanism so that the controller device is enabled to determine a price of the certain object based on the weight measurement of that object.

In one exemplary embodiment, a sensor device is operationally coupled to a controller device. The sensor device is also configured to be coupled to the shopping cart, with the sensor device having a coupling mechanism configured to suspend a container from the sensor device and processing circuitry operationally coupled to a weight sensor operable to measure a weight of the container while suspended from the sensor device by the coupling mechanism. The sensor device further includes a memory electrically coupled to the processing circuitry, the memory containing instructions executable by the processing circuitry, whereby the processing circuitry is configured to send, to the controller device, an indication that includes a weight measurement of a certain object of a set of objects that is disposed in the container while the container is suspended from the sensor device by the coupling mechanism so that the controller device is enabled to determine a price of the certain object based on the weight measurement of that object.

In one exemplary embodiment, a method is performed by a controller device that is configured to be coupled to a shopping cart and operationally coupled to a sensor device that is also configured to be coupled to the shopping cart. The sensor device has a coupling mechanism configured to suspend a container from the sensor device and a weight sensor operable to measure a weight of the container while suspended from the sensor device by the coupling mechanism. The method includes receiving, by the controller device, from the sensor device, an indication that includes a weight measurement of a certain object of a set of objects that is disposed in the container while the container is suspended from the sensor device by the coupling mechanism so that the controller device is enabled to determine a price of the certain object based on the weight measurement of that object.

In one exemplary embodiment, a controller device is configured to be coupled to a shopping cart and operationally coupled to a sensor device that is also configured to be coupled to the shopping cart. The sensor device has a coupling mechanism configured to suspend a container from the sensor device and a weight sensor operable to measure a weight of the container while suspended from the sensor device by the coupling mechanism. The controller device further includes a processing circuitry and a memory, the memory containing instructions executable by the processing circuitry whereby the processing circuitry is configured to receive, from the sensor device, an indication that includes a weight measurement of a certain object of a set of objects that is disposed in the container while the container is suspended from the sensor device by the coupling mechanism so that the controller device is enabled to determine a price of the certain object based on the weight measurement of that object.

In one exemplary embodiment a method is performed by an apparatus configured to be coupled to a shopping cart. The apparatus has a coupling mechanism configured to suspend a container from the apparatus and processing circuitry operationally coupled to a weight sensor that is operable to measure a weight of the container while suspended from the apparatus by the coupling mechanism. The method includes receiving, by the processing circuitry, from the weight sensor, an indication that includes a weight measurement of a certain object of a set of objects that is disposed in the container while the container is suspended from the sensor device by the coupling mechanism so that the processing circuitry is enabled to determine a price of the certain object based on the weight measurement of that object.

In one exemplary embodiment, an apparatus is configured to be coupled to a shopping cart. The apparatus has a coupling mechanism configured to suspend a container from the apparatus and processing circuitry operationally coupled to a weight sensor that is operable to measure a weight of the container while suspended from the apparatus by the coupling mechanism. The apparatus further includes a memory operationally coupled to the processing circuitry, the memory containing instructions executable by the processing circuitry whereby the processing circuitry is configured to receive, from the weight sensor, an indication that includes a weight measurement of a certain object of a set of objects that is disposed in the container while the container is suspended from the sensor device by the coupling mechanism so that the processing circuitry is enabled to determine a price of the certain object based on the weight measurement of that object.

In one exemplary embodiment, a method is performed by a controller device that is configured to be coupled to a mounting mechanism disposed on a shopping cart. The mounting mechanism has a coupling mechanism configured to suspend a container from the mounting mechanism and a weight sensor operable to measure a weight of the container while suspended from the mounting mechanism by the coupling mechanism. The controller device further has processing circuitry electrically coupled to the weight sensor while the controller device is coupled to the mounting mechanism. The method includes receiving, by the processing circuitry, from the weight sensor, an indication that includes a weight measurement of a certain object of a set of objects that is disposed in the container while the container is suspended from the mounting mechanism by the coupling mechanism so that the processing circuitry is enabled to determine a price of the certain object based on the weight measurement of that object.

In one exemplary embodiment, a controller device is configured to be coupled to a mounting mechanism disposed on a shopping cart. The mounting mechanism has a coupling mechanism configured to suspend a container from the mounting mechanism and a weight sensor operable to measure a weight of the container while suspended from the mounting mechanism by the coupling mechanism. The controller device further has processing circuitry electrically coupled to the weight sensor while the controller device is coupled to the mounting mechanism, and the controller device further includes a memory electrically coupled to the processing circuitry, the memory containing instructions executable by the processing circuitry whereby the processing circuitry is configured to receive, from the weight sensor, an indication that includes a weight measurement of a certain object of a set of objects that is disposed in the container while the container is suspended from the mounting mechanism by the coupling mechanism so that the processing circuitry is enabled to determine a price of the certain object based on the weight measurement of that object.

In one exemplary embodiment, a method is performed by a mounting mechanism configured to be coupled to a controller device and disposed on a shopping cart. The mounting mechanism has a coupling mechanism configured to suspend a container from the mounting mechanism and a weight sensor operable to measure a weight of the container while suspended from the mounting mechanism by the coupling mechanism. The controller device has processing circuitry electrically coupled to the weight sensor while the controller device is coupled to the mounting mechanism. The method includes sending, by the weight sensor, to the processing circuitry, an indication that includes a weight measurement of a certain object of a set of objects that is disposed in the container while the container is suspended from the mounting mechanism by the coupling mechanism so that the processing circuitry is enabled to determine a price of the certain object based on the weight measurement of that object.

In one exemplary embodiment, a mounting mechanism is configured to be coupled to a controller device and disposed on a shopping cart. The mounting mechanism has a coupling mechanism configured to suspend a container from the mounting mechanism and a weight sensor operable to measure a weight of the container while suspended from the mounting mechanism by the coupling mechanism. The controller device has a processing circuitry electrically coupled to the weight sensor while the controller device is coupled to the mounting mechanism. The weight sensor is operable to send, to the processing circuitry of the controller device, an indication that includes a weight measurement of a certain object of a set of objects that is disposed in the container while the container is suspended from the mounting mechanism by the coupling mechanism so that the processing circuitry is enabled to determine a price of the certain object based on the weight measurement of that object.

In one exemplary embodiment, a method is performed by an apparatus configured to be coupled to a shopping cart, with the apparatus having a coupling mechanism configured to suspend a container from the apparatus and processing circuitry operationally coupled to a weight sensor operable to measure a weight of an object that is disposed in the container while suspended from the apparatus by the coupling mechanism and has a weight-dependent price. The method includes sending, by the processing circuitry, an indication associated with the price of the object.

In another exemplary embodiment, the method further includes determining to obtain a weight measurement.

In another exemplary embodiment, the method further includes receiving by the processing circuitry, from an input device of the apparatus, an indication that includes a selected retail item that corresponds to the object.

In another exemplary embodiment, the method further includes determining, based on the selected retail item, that a weight measurement of the object is requested.

In another exemplary embodiment, the method further includes sending, by the processing circuitry, to a display device of the apparatus, an indication that includes a visual representation associated with a request to perform the weight measurement.

In another exemplary embodiment, the method further includes determining that the apparatus is stationary.

In another exemplary embodiment, the method further includes sending, by the processing circuitry, to a motion sensor of the apparatus, an indication that includes a request for a motion measurement.

In another exemplary embodiment, the method further includes receiving, by the processing circuitry, from a motion sensor of the apparatus, an indication that includes a motion measurement.

In another exemplary embodiment, the method further includes obtaining a weight measurement of the object.

In another exemplary embodiment, the method further includes sending, by the processing circuitry, to the weight sensor, an indication that includes a request for a weight measurement.

In another exemplary embodiment, the method further includes receiving, by the processing circuitry, from the weight sensor, an indication that includes a weight measurement.

In another exemplary embodiment, the method further includes obtaining a weight-related price of the selected retail item.

In another exemplary embodiment, the method further includes sending, by the processing circuitry, to a network node, over a network, an indication that includes a request to query a price per unit of weight for the selected retail item.

In another exemplary embodiment, the method further includes receiving, by the processing circuitry, from a network node, over a network, an indication that includes the price per unit of weight of the selected retail item.

In another exemplary embodiment, the method further includes determining the price of the object based on the weight measurement and the weight-related price of the selected retail item.

In another exemplary embodiment, the method further includes determining to verify that the selected retail item corresponds to the object.

In another exemplary embodiment, the method further includes obtaining image data that represents an image that displays the object while disposed in the container suspended from the apparatus by the coupling mechanism.

In another exemplary embodiment, the method further includes sending, by the processing circuitry, to an optical sensor of the apparatus that has a downward field of view and is operable to capture an image, an indication that includes a request to capture an image.

In another exemplary embodiment, the method further includes receiving, by the processing circuitry, from the optical sensor an indication that includes data representing an image that displays the object.

In another exemplary embodiment, the method further includes classifying or identifying the object based on the weight measurement or the image data.

In another exemplary embodiment, the method further includes sending, by the processing circuitry, to an artificial intelligence circuit, an indication that includes a request to predict, based on the weight measurement or the image data, a retail item corresponding to the object from a set of retail items, wherein the artificial intelligence circuit is trained on information associated with the set of retail items.

In another exemplary embodiment, the method further includes receiving, by the processing circuitry, from the artificial intelligence circuit, an indication that includes at least one of the set of retail items and a corresponding confidence level.

In another exemplary embodiment, the method further includes selecting one of the at least one of the set of retail items based on the corresponding confidence levels to obtain a predicted retail item.

In another exemplary embodiment, the method further includes determining that the selected retail item corresponds to the predicted retail item.

In another exemplary embodiment, the method further includes determining that the selected retail item does not correspond to the predicted retail item.

In another exemplary embodiment, the method further includes sending, by the processing circuitry, to a display device of the apparatus, an indication that the selected retail item does not correspond to the predicted retail item.

In another exemplary embodiment, the weight sensor in the method is weights and measures-certified.

In another exemplary embodiment, the apparatus in the method is configured to be coupled to the shopping cart through a mounting mechanism disposed on the shopping cart, wherein the mounting mechanism and apparatus are electrically coupled such that the mounting mechanism is operable to supply power to the apparatus.

In one exemplary embodiment, an apparatus comprises an apparatus that is configured to be coupled to a shopping cart, with the apparatus having a coupling mechanism configured to suspend a container from the apparatus and processing circuitry operationally coupled to a weight sensor operable to measure a weight of an object that is disposed in the container while suspended from the apparatus by the coupling mechanism, wherein the object has a weight-dependent price. The apparatus further comprises a memory operationally coupled to the processing circuitry with the memory containing instructions executable by the processing circuitry whereby the processing circuitry is configured to send an indication associated with the price of the object.

In one exemplary embodiment, a system comprises a shopping cart and an apparatus configured to be coupled to the shopping cart, with the apparatus having a coupling mechanism configured to suspend a container from the apparatus and processing circuitry operationally coupled to a weight sensor operable to measure a weight of an object while it is disposed in the container that is suspended from the apparatus by the coupling mechanism, with the apparatus being operable to send, by the processing circuitry, an indication associated with the price of the object.

In one exemplary embodiment, a method is performed by an apparatus configured to be mechanically coupled to a cart, with the apparatus having a coupling mechanism configured to suspend a container from the apparatus and a processing circuitry operationally coupled to a weight sensor operable to measure a weight of an object disposed in the container while suspended from the apparatus by the coupling mechanism. The method includes sending, by processing circuitry, an indication associated with a weight-related price of an object based on the weight measurement of the object disposed in the container while suspended from the apparatus by the coupling mechanism and a price per unit of weight of a selected retail item that corresponds to the object.

In another exemplary embodiment, the method further includes receiving, by the processing circuitry, from a presence sensitive display device of the apparatus, an indication that includes a selected retail item that corresponds to the object and determining to obtain a weight measurement of the object based on the selected retail item.

In another exemplary embodiment, the method further includes sending, by the processing circuitry, to the presence sensitive display device, an indication that includes a visual representation associated with a request to perform a weight measurement of the object.

In another exemplary embodiment, the method further includes determining to obtain a weight measurement of the object, sending, by the processing circuitry, to a motion sensor of the apparatus, an indication that includes a request for a motion-related measurement of the apparatus, receiving, by the processing circuitry, from the motion sensor, an indication that includes the motion measurement of the apparatus, determining that the apparatus is stationary based on the motion measurement; sending, by the processing circuitry, to the weight sensor, an indication that includes a request for a weight measurement, and receiving, by the processing circuitry, from the weight sensor, an indication that includes the weight measurement.

In another exemplary embodiment, the method further includes obtaining the weight measurement of the container and determining the weight of the object based on the weight measurement and the weight of the container.

In another exemplary embodiment, the method further includes obtaining the selected retail item that corresponds to the object, obtaining a weight measurement of the object, verifying that the selected retail item corresponds to the object based on the weight measurement of the object, obtaining a price per unit of weight of the selected retail item, and determining the weight-related price of the object based on the weight measurement of the object and the price per unit of weight of the selected retail item.

In another exemplary embodiment, the method further includes sending, by the processing circuitry, to an optical sensor of the apparatus that has a downward field of view and is operable to capture an image, an indication that includes a request to capture an image, receiving, by the processing circuitry, from the optical sensor, an indication that includes data representing an image that displays the object disposed in the container, sending, by the processing circuitry, to an artificial intelligence circuit, an indication that includes a request to predict, based on the weight measurement or the image data, a retail item corresponding to the object from a set of retail items, wherein the artificial intelligence circuit is trained on information associated with the set of retail items, receiving, by the processing circuitry, from the artificial intelligence circuit, an indication that includes at least one of the set of retail items and a corresponding confidence level, and selecting one of the at least one of the set of retail items based on the corresponding confidence levels to obtain the selected retail item.

In another exemplary embodiment, the apparatus in the method further includes a presence sensitive display with the processing circuitry being electrically coupled to the weight sensor and the presence sensitive display.

In another exemplary embodiment, the apparatus in the method is further configured to include a controller device and a mounting mechanism configured to be mechanically coupled to the cart, the controller device having a processing circuitry electrically coupled to a first electrical coupler and a presence sensitive display, the mounting mechanism having a second electrical coupler, the coupling mechanism and the weight sensor, with the processing circuitry being further electrically coupled to the weight sensor while the controller device is mechanically coupled to the mounting mechanism such that the first and second electrical couplers are electrically coupled.

In another exemplary embodiment, the apparatus in the method is further configured to include a controller device and a sensor device with both configured to be mechanically coupled to the cart, the controller device having a first processing circuitry electrically coupled to a presence sensitive display, the sensor device having the coupling mechanism and a second processing circuitry electrically coupled to the weight sensor, with the first and second processing circuitry being operationally coupled such that the first processing circuitry is operationally coupled to the weight sensor through the second processing circuitry.

In one exemplary embodiment, an apparatus comprises an apparatus configured to be mechanically coupled to a cart, with the apparatus having a coupling mechanism configured to suspend a container from the apparatus and a processing circuitry operationally coupled to a weight sensor operable to measure a weight of the object disposed in the container while suspended from the apparatus by the coupling mechanism. The apparatus further comprises a memory operationally coupled to the processing circuitry, the memory containing instructions executable by the processing circuitry whereby the processing circuitry is configured to send an indication associated with a weight-related price of an object based on the weight measurement of the object disposed in the container while suspended from the apparatus by the coupling mechanism and a price per unit of weight of a selected retail corresponding to the object.

In another exemplary embodiment, the memory of the apparatus contains further instructions executable by the processor whereby the processor is further configured to receive, by the processing circuitry, from a presence sensitive display device of the apparatus, an indication that includes a selected retail item that corresponds to the object and determine to obtain a weight measurement of the object based on the selected retail item.

In another exemplary embodiment, the memory of the apparatus contains further instructions executable by the processor whereby the processor is further configured to send, by the processing circuitry, to the presence sensitive display device, an indication that includes a visual representation associated with a request to perform a weight measurement of the object.

In another exemplary embodiment, the memory of the apparatus contains further instructions executable by the processor whereby the processor is further configured to determine to obtain a weight measurement of the object, send, by the processing circuitry, to a motion sensor of the apparatus, an indication that includes a request for a motion-related measurement of the apparatus, receive, by the processing circuitry, from the motion sensor, an indication that includes the motion measurement of the apparatus, determine that the apparatus is stationary based on the motion measurement, send, by the processing circuitry, to the weight sensor, an indication that includes a request for a weight measurement, and receive, by the processing circuitry, from the weight sensor, an indication that includes the weight measurement.

In another exemplary embodiment, the memory of the apparatus contains further instructions executable by the processor whereby the processor is further configured to obtain a selected retail item that corresponds to the object, obtain a weight measurement of the object, verify that the selected retail item corresponds to the object based on the weight measurement of the object, obtain a price per unit of weight of the selected retail item, and determine the weight-related price of the object based on the weight measurement of the object and the price per unit of weight of the selected retail item.

In another exemplary embodiment, the memory of the apparatus contains further instructions executable by the processor whereby the processor is further configured to send, by the processing circuitry, to an optical sensor of the apparatus that has a downward field of view and is operable to capture an image, an indication that includes a request to capture an image, receive, by the processing circuitry, from the optical sensor, an indication that includes data representing an image that displays the object disposed in the container, send, by the processing circuitry, to an artificial intelligence circuit, an indication that includes a request to predict, based on the weight measurement or the image data, a retail item corresponding to the object from a set of retail items, wherein the artificial intelligence circuit is trained on information associated with the set of retail items, receive, by the processing circuitry, from the artificial intelligence circuit, an indication that includes at least one of the set of retail items and a corresponding confidence level, and select one of the at least one of the set of retail items based on the corresponding confidence levels to obtain the selected retail item.

In another exemplary embodiment, the apparatus further includes a presence sensitive display with the processing circuitry being electrically coupled to the weight sensor and the presence sensitive display.

In another exemplary embodiment, the apparatus is further configured to include a controller device and a mounting mechanism configured to be mechanically coupled to the cart, the controller device having a processing circuitry electrically coupled to a first electrical coupler and a presence sensitive display, the mounting mechanism having a second electrical coupler, the coupling mechanism and the weight sensor, with the processing circuitry being further electrically coupled to the weight sensor while the controller device is mechanically coupled to the mounting mechanism such that the first and second electrical couplers are electrically coupled.

In another exemplary embodiment, the apparatus is further configured to include a controller device and a sensor device with both configured to be mechanically coupled to the cart, the controller device having a first processing circuitry electrically coupled to a presence sensitive display, the sensor device having the coupling mechanism and a second processing circuitry electrically coupled to the weight sensor, with the first and second processing circuitry being operationally coupled such that the first processing circuitry is operationally coupled to the weight sensor through the second processing circuitry.

In one exemplary embodiment, a system comprises a cart and an apparatus configured to be mechanically coupled to the cart, with the apparatus having a coupling mechanism configured to suspend a container from the apparatus and a processing circuitry operationally coupled to a weight sensor operable to measure a weight of the object disposed in the container while suspended from the apparatus by the coupling mechanism, with the apparatus being operable to send, by processing circuitry, an indication associated with a weight-related price of an object based on the weight measurement of the object disposed in the container while suspended from the apparatus by the coupling mechanism and the price per unit of weight of a selected retail item corresponding to the object.

The previous detailed description is merely illustrative in nature and is not intended to limit the present disclosure, or the application and uses of the present disclosure. Furthermore, there is no intention to be bound by any expressed or implied theory presented in the preceding field of use, background, summary, or detailed description. The present disclosure provides various examples, embodiments and the like, which may be described herein in terms of functional or logical block elements. The various aspects described herein are presented as methods, devices (or apparatus), systems, or articles of manufacture that may include a number of components, elements, members, modules, nodes, peripherals, or the like. Further, these methods, devices, systems, or articles of manufacture may include or not include additional components, elements, members, modules, nodes, peripherals, or the like.

Furthermore, the various aspects described herein may be implemented using standard programming or engineering techniques to produce software, firmware, hardware (e.g., circuits), or any combination thereof to control a computing device to implement the disclosed subject matter. It will be appreciated that some embodiments may be comprised of one or more generic or specialized processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the methods, devices and systems described herein. Alternatively, some or all functions could be implemented by a state machine that has no stored program instructions, or in one or more application specific integrated circuits (ASICs), in which each function or some combinations of certain of the functions are implemented as custom logic circuits. Of course, a combination of the two approaches may be used. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The term “article of manufacture” as used herein is intended to encompass a computer program accessible from any computing device, carrier, or media. For example, a computer-readable medium may include: a magnetic storage device such as a hard disk, a floppy disk or a magnetic strip; an optical disk such as a compact disk (CD) or digital versatile disk (DVD); a smart card; and a flash memory device such as a card, stick or key drive. Additionally, it should be appreciated that a carrier wave may be employed to carry computer-readable electronic data including those used in transmitting and receiving electronic data such as electronic mail (e-mail) or in accessing a computer network such as the Internet or a local area network (LAN). Of course, a person of ordinary skill in the art will recognize many modifications may be made to this configuration without departing from the scope or spirit of the subject matter of this disclosure.

Throughout the specification and the embodiments, the following terms take at least the meanings explicitly associated herein, unless the context clearly dictates otherwise. Relational terms such as “first” and “second,” and the like may be used solely to distinguish one entity or action from another entity or action without necessarily requiring or implying any actual such relationship or order between such entities or actions. The term “or” is intended to mean an inclusive “or” unless specified otherwise or clear from the context to be directed to an exclusive form. Further, the terms “a,” “an,” and “the” are intended to mean one or more unless specified otherwise or clear from the context to be directed to a singular form. The term “include” and its various forms are intended to mean including but not limited to. References to “one embodiment,” “an embodiment,” “example embodiment,” “various embodiments,” and other like terms indicate that the embodiments of the disclosed technology so described may include a particular function, feature, structure, or characteristic, but not every embodiment necessarily includes the particular function, feature, structure, or characteristic. Further, repeated use of the phrase “in one embodiment” does not necessarily refer to the same embodiment, although it may. The terms “substantially,” “essentially,” “approximately,” “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. A device or structure that is “configured” in a certain way is configured in at least that way, but may also be configured in ways that are not listed.

What is claimed is:

1. A method, comprising:
by an apparatus configured to be mechanically coupled to a cart, with the apparatus having a coupling mechanism configured to suspend a container from the apparatus and a processing circuitry operationally coupled to a weight sensor operable to measure a weight of an object disposed in the container while suspended from the apparatus by the coupling mechanism,
sending, by processing circuitry, an indication associated with a weight-related price of an object based on the weight measurement of the object disposed in the container while suspended from the apparatus by the coupling mechanism and a price per unit of weight of a selected retail item that corresponds to the object.

2. The method of claim 1, further comprising:
receiving, by the processing circuitry, from a presence sensitive display device of the apparatus, an indication that includes a selected retail item that corresponds to the object; and
determining to obtain a weight measurement of the object based on the selected retail item.

3. The method of claim 2, further comprising:
sending, by the processing circuitry, to the presence sensitive display device, an indication that includes a visual representation associated with a request to perform a weight measurement of the object.

4. The method of claim 1, further comprising:
determining to obtain a weight measurement of the object;
sending, by the processing circuitry, to a motion sensor of the apparatus, an indication that includes a request for a motion-related measurement of the apparatus;
receiving, by the processing circuitry, from the motion sensor, an indication that includes the motion measurement of the apparatus;
determining that the apparatus is stationary based on the motion measurement;
sending, by the processing circuitry, to the weight sensor, an indication that includes a request for a weight measurement; and
receiving, by the processing circuitry, from the weight sensor, an indication that includes the weight measurement.

5. The method of claim 4, further comprising:
obtaining the weight measurement of the container; and
determining the weight of the object based on the weight measurement and the weight of the container.

6. The method of claim 1, further comprising:
obtaining a selected retail item that corresponds to the object;
obtaining a weight measurement of the object;
verifying that the selected retail item corresponds to the object based on the weight measurement of the object;
obtaining a price per unit of weight of the selected retail item; and
determining the weight-related price of the object based on the weight measurement of the object and the price per unit of weight of the selected retail item.

7. The method of claim 6, wherein the step of obtaining the selected retail item includes:
sending, by the processing circuitry, to an optical sensor of the apparatus that has a downward field of view and is operable to capture an image, an indication that includes a request to capture an image;
receiving, by the processing circuitry, from the optical sensor, an indication that includes data representing an image that displays the object disposed in the container;
sending, by the processing circuitry, to an artificial intelligence circuit, an indication that includes a request to predict, based on the weight measurement or the image data, a retail item corresponding to the object from a set of retail items, wherein the artificial intelligence circuit is trained on information associated with the set of retail items;
receiving, by the processing circuitry, from the artificial intelligence circuit, an indication that includes at least one of the set of retail items and a corresponding confidence level; and
selecting one of the at least one of the set of retail items based on the corresponding confidence levels to obtain the selected retail item.

8. The method of claim 1, wherein the apparatus further includes a presence sensitive display with the processing circuitry being electrically coupled to the weight sensor and the presence sensitive display.

9. The method of claim 1, wherein the apparatus is further configured to include a controller device and a mounting mechanism configured to be mechanically coupled to the cart, the controller device having a processing circuitry electrically coupled to a first electrical coupler and a presence sensitive display, the mounting mechanism having a second electrical coupler, the coupling mechanism and the weight sensor, with the processing circuitry being further electrically coupled to the weight sensor while the controller device is mechanically coupled to the mounting mechanism such that the first and second electrical couplers are electrically coupled.

10. The method of claim 1, wherein the apparatus is configured to include a controller device and a sensor device with both configured to be mechanically coupled to the cart, the controller device having a first processing circuitry electrically coupled to a presence sensitive display, the sensor device having the coupling mechanism and a second processing circuitry electrically coupled to the weight sensor, with the first and second processing circuitry being operationally coupled such that the first processing circuitry is operationally coupled to the weight sensor through the second processing circuitry.

11. An apparatus, comprising:
with the apparatus configured to be mechanically coupled to a cart, with the apparatus having a coupling mechanism configured to suspend a container from the apparatus and a processing circuitry operationally coupled to a weight sensor operable to measure a weight of the object disposed in the container while suspended from the apparatus by the coupling mechanism; and
wherein the apparatus further comprises a memory operationally coupled to the processing circuitry, the memory containing instructions executable by the processing circuitry whereby the processing circuitry is configured to:
send an indication associated with a weight-related price of an object based on the weight measurement of the object disposed in the container while suspended from the apparatus by the coupling mechanism and a price per unit of weight of a selected retail corresponding to the object.

12. The apparatus of claim 11, wherein the memory includes further instructions executable by the processing circuitry whereby the apparatus is configured to:
receive, by the processing circuitry, from a presence sensitive display device of the apparatus, an indication that includes a selected retail item that corresponds to the object; and
determine to obtain a weight measurement of the object based on the selected retail item.

13. The apparatus of claim 12, wherein the memory includes further instructions executable by the processing circuitry whereby the apparatus is configured to:
send, by the processing circuitry, to the presence sensitive display device, an indication that includes a visual representation associated with a request to perform a weight measurement of the object.

14. The apparatus of claim 11, wherein the memory includes further instructions executable by the processing circuitry whereby the apparatus is configured to:
determine to obtain a weight measurement of the object;
send, by the processing circuitry, to a motion sensor of the apparatus, an indication that includes a request for a motion-related measurement of the apparatus;
receive, by the processing circuitry, from the motion sensor, an indication that includes the motion measurement of the apparatus;
determine that the apparatus is stationary based on the motion measurement;
send, by the processing circuitry, to the weight sensor, an indication that includes a request for a weight measurement; and
receive, by the processing circuitry, from the weight sensor, an indication that includes the weight measurement.

15. The apparatus of claim 11, wherein the memory includes further instructions executable by the processing circuitry whereby the apparatus is configured to:
obtain a selected retail item that corresponds to the object;
obtain a weight measurement of the object;
verify that the selected retail item corresponds to the object based on the weight measurement of the object;
obtain a price per unit of weight of the selected retail item; and
determine the weight-related price of the object based on the weight measurement of the object and the price per unit of weight of the selected retail item.

16. The apparatus of claim 15, wherein the memory includes further instructions executable by the processing circuitry whereby the apparatus is configured to:
send, by the processing circuitry, to an optical sensor of the apparatus that has a downward field of view and is operable to capture an image, an indication that includes a request to capture an image;
receive, by the processing circuitry, from the optical sensor, an indication that includes data representing an image that displays the object disposed in the container;
send, by the processing circuitry, to an artificial intelligence circuit, an indication that includes a request to predict, based on the weight measurement or the image data, a retail item corresponding to the object from a set of retail items, wherein the artificial intelligence circuit is trained on information associated with the set of retail items;
receive, by the processing circuitry, from the artificial intelligence circuit, an indication that includes at least one of the set of retail items and a corresponding confidence level; and
select one of the at least one of the set of retail items based on the corresponding confidence levels to obtain the selected retail item.

17. The apparatus of claim 11, wherein the apparatus further includes a presence sensitive display with the processing circuitry being electrically coupled to the weight sensor and the presence sensitive display.

18. The apparatus of claim 11, wherein the apparatus is further configured to include a controller device and a mounting mechanism configured to be mechanically coupled to the cart, the controller device having a processing circuitry electrically coupled to a first electrical coupler and a presence sensitive display, the mounting mechanism having a second electrical coupler, the coupling mechanism and the weight sensor, with the processing circuitry being further electrically coupled to the weight sensor while the controller device is mechanically coupled to the mounting mechanism such that the first and second electrical couplers are electrically coupled.

19. The apparatus of claim 11, wherein the apparatus is further configured to include a controller device and a sensor device with both configured to be mechanically coupled to the cart, the controller device having a first processing circuitry electrically coupled to a presence sensitive display, the sensor device having the coupling mechanism and a second processing circuitry electrically coupled to the weight sensor, with the first and second processing circuitry being operationally coupled such that the first processing circuitry is operationally coupled to the weight sensor through the second processing circuitry.

20. A system, comprising:
a cart; and
an apparatus configured to be mechanically coupled to the cart, with the apparatus having a coupling mechanism configured to suspend a container from the apparatus and a processing circuitry operationally coupled to a weight sensor operable to measure a weight of the object disposed in the container while suspended from the apparatus by the coupling mechanism, with the apparatus being operable to:
send, by processing circuitry, an indication associated with a weight-related price of an object based on the weight measurement of the object disposed in the container while suspended from the apparatus by the coupling mechanism and the price per unit of weight of a selected retail item corresponding to the object.
